(19) United States
(12) Patent Application Publication
(10) Pub. No.: US 2002/0125401 A1
(43) Pub. Date: Sep. 12, 2002

(54) Mount for display systems

(76) Inventors: Stephen R. Szumita, North Hampton, NH (US); Raymond J. Pineau, Windham, NH (US); Robert W. Bradbury, Merrimack, NH (US); Todd A. Newville, Shrewbury, MA (US)

Correspondence Address: FRANK R. OCCHUITTI, Fish & Richardson P.C., 225 Franklin Street, Boston, MA, 02110-2804, US

(21) Appl. No.: 10/076,800

(22) Filed: Oct. 25, 2001

Related U.S. Application Data
(60) Provisional application No. 60/243,109, filed on Oct. 25, 2000.

(51) Int. Cl. F16M 11/00; B23P 11/00

(52) U.S. Cl. 248/694; 29/428; 248/918

(57) ABSTRACT

The invention features a system for mounting a display onto a panel having an opening. The system includes a first plate supporting the display and contacting a first surface of the panel, a second plate configured to contact a second surface opposite the first, and a fastening mechanism for mounting the first member and the second member through the opening of the panel.

### TECHNICAL FIELD

This invention relates to mounting systems for display screens, such as video monitors.

### BACKGROUND

Typically, information such as advertising, news, messages, and the like were conveyed in conventional types of displays such as poster boards, placards, advertising boards, billboards of various sizes, and the like. However, with the advent of electronic media and the impact of the digital technology on the dissemination of information and data, electronic displays are playing an increasing role not only in the delivery of information but also in its presentation and display. For example, holes may be pre-cut in an elevator panel to support visual floor indicators.

### SUMMARY

The invention features a system for mounting a display onto a panel having an opening.

In one aspect of the invention, the system includes a first plate supporting the display and contacting a first surface of the panel, a second plate configured to contact a second surface opposite the first surface of the panel, and a fastening mechanism for mounting the first plate and the second plate through the opening.

In another aspect of the invention, a method for mounting a display onto a panel having an opening includes: (a) providing a first plate supporting the display and contacting a first surface of the panel; (b) providing a second plate configured to contact a second surface opposite the first surface of the panel; and (c) providing a fastening mechanism for mounting the first plate and to the second plate through the opening.

Embodiments of these aspects of the invention may include one or more of the following features.

The first plate includes a support surface for supporting the display and an opposite surface contacting the front surface of the panel. The first plate further includes fastening members, and the second plate includes openings.

The fastening mechanism includes fastening members configured to be inserted through the opening of the panel and connect to the openings of the second plate.

The system further includes a mounting box mechanically coupled with the second plate.

The opposite surface of the first plate includes a display cable that is inserted through the opening of the panel. The second plate further includes a panel contact surface contacting the opposite surface of the panel, an opposite surface, and a cable opening for inserting the display cable through the opening. The opposite surface of the second plate includes fastening members for mounting the second panel to the mounting box.

As another feature, the number of openings in the second plate is greater than the number of fastening members of the first plate. The fastening members are threaded studs, and the fastening mechanism includes threaded lockers attached to the threaded studs.

In another aspect of the invention, a method for mounting a display onto a panel includes: (a) providing an opening in the panel; (b) providing a first plate supporting the display; (c) attaching the first plate to a first surface of the panel with the first plate positioned relative to the opening of the panel; (d) providing a second plate configured to contact a second surface opposite the first surface of the panel; (e) attaching the second plate to the second surface of the panel with the second plate positioned relative to the opening of the panel; and (f) fastening the first plate and second plate through the opening of the panel.

Embodiments of this aspect of the invention may include one or more of the following features.

The method further includes removing a pre-existing display from the panel prior to providing the opening in the panel.

As another feature, the opening in the panel is provided prior to attaching the first plate to the first surface of the panel.

Embodiments may have one or more of the following advantages.

A display system (e.g., video monitor or flat panel display), to be properly positioned for viewing, must be securely mounted to a stable surface. In certain cases, the surface to which the system is mounted is visible to viewers of the display system. Thus, mounting of the display should not scratch, mar or otherwise scrape the visible portion of the surface. Furthermore, installation of the system should not impair the structural integrity of the surrounding area. For a display system provided in an elevator cab, the surface used for mounting the system may include a pre-existing hole through which the display system is installed.

One of the benefits of the present system and method is the use of these pre-existing holes or apertures in the wall of elevator cabs for installing elevator display units. This system is particularly attractive because there is no need to cut additional holes or cause any structural changes in the wall of elevator cabs. The present system allows efficient, convenient, and economical installation of display units by using already-existing apertures. Where a pre-existing hole is not available, a hole much smaller than the display system itself can be provided to accommodate the display system.

Furthermore, the present system and method prevents loss of parts by providing an effective, integrated way of packaging the required display installation components so that the unit can be stored in an assembled condition until it is delivered to the installation site, thereby minimizing the possibility of losing parts.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1a-1c illustrate side views of a display and mounting system relative to an elevator cab panel assembly.

FIG. 2 is a front view of the elevator cab panel.

FIG. 3 is a front view of the elevator cab panel of FIG. 2 with an installed display.

FIG. 4 is a rear view of the display portion of mounting system, and elevator cab panel of FIG. 1.

FIG. 5 is a rear view of the portion of mounting system and panel of FIG. 4 with a mounting plate.

FIG. 6 is a rear view of the panel of FIG. 5 with a mounting box installed on rear of mounting system.

FIG. 7 is a plan view of a mounting plate.

FIGS. 8a-8d illustrate different configurations of mounting systems relative to an opening in the elevator cab panel.

FIG. 9 is an exploded, perspective view display, of a mounting system relative to a panel.

FIGS. 10a-10c illustrate one example of a panel assembly mounting operation.

### DETAILED DESCRIPTION

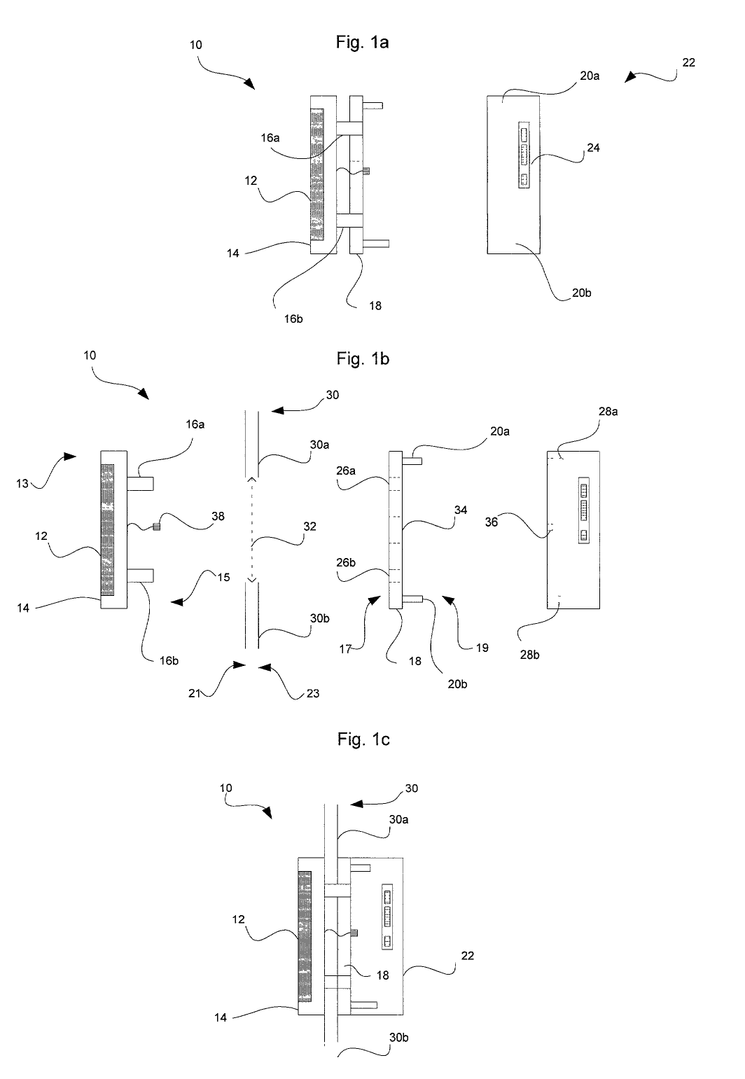

Referring to FIGS. 1a-1c, a display assembly unit 10 is shown to include a display plate 14 which mechanically supports a display 12 within an elevator cab for viewing images and displaying various types of video information. The display 12 can be a flat panel liquid crystal display (LCD) screen. For example, video information message can include combinations of different types of information (advertising, news, weather, “real-time” general information, as well as, building-related information, and the like). An example of a system for displaying such information can be found in U.S. Pat. Nos. 5,955,710 and 6,073,727, both incorporated by reference herein. Display assembly unit 10 also includes a mounting plate 18 attached to a rear surface of display plate 14.

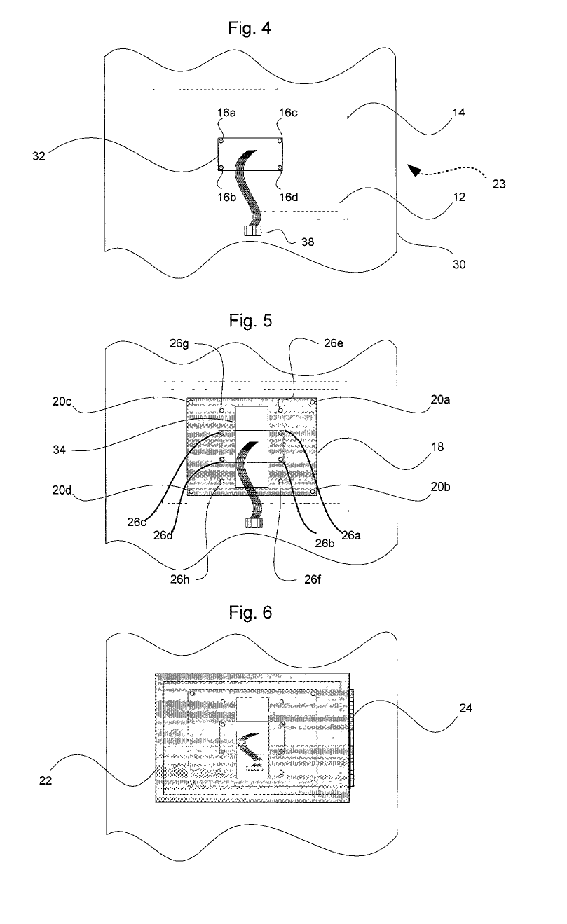

The display plate 14 also includes threaded studs 16a-16d (FIG. 4). The threaded studs 16a-16d serve as fastening devices for mechanically connecting the display plate 14 to the mounting plate 18 (FIG. 1A). In addition, the display plate 14 includes a support surface 13 for supporting the display 12 and an opposite surface 15 directly across from or facing the support surface 13. The display plate 14 also includes a display cable 38 such as a video interface of the display assembly unit 10. In particular, the display cable 38 is an LCD video cable and an inverter power cable for connecting the display assembly unit 10 to an electrical and data source (not shown).

The mounting plate 18 includes mounting threaded studs 20a-20d (FIG. 5). The mounting threaded studs 20 serve as fastening members for mechanically connecting the mounting plate 18 to a mounting box 22 (FIG. 1a-1c). The mounting box 22 encloses the electrical components and connection wiring required for a proper function of the display 12. The mounting plate 18 also includes mounting plate openings 26a-26h (FIG. 5). The mounting plate 18 also includes a panel contact surface 17 and an opposite surface 19 (FIG. 1b) directly across from or facing the panel contact surface 17. The mounting plate 18 includes a cable opening 34 (FIG. 5) where the display cable 38 can be inserted through the cable opening 34.

Still referring to FIG. 1a-1c, the mounting box 22 includes a connector 36 such as an LCD video connector for receiving the display cable 38, mounting box apertures 28a and 28b (collectively, mounting box apertures 28) and a communications interface 24 for providing the required signals or video information for the display 12. The mounting box 22 also includes inverter power cable access holes for receiving the inverter power cable of the display assembly unit 10.

In particular, FIG. 1a shows the display assembly unit 10 as an integral unit, for example, in the form in which display assembly unit would be transported to the location of installation. The display assembly unit 10, thus, arrives at the installation site, as an assembled unit to prevent the loss of parts.

Referring to FIG. 1b, the display assembly unit 10 is shown disassembled and ready for installation within a cab operator panel 30 of an elevator unit. The panel 30 is typically formed of a relatively rigid, high strength material, such as 0.125″ to 0.250″ (inches) thick aluminum or stainless steel. The panel 30 includes a front surface 21 and a rear surface 23. The panel 30 also includes an upper section 30a and a lower section 30b defining a panel opening 32 therebetween. The panel opening 32 is an aperture typically having a dimension of approximately 3″×5″ (inches). In many installations, the panel opening 32 already exists in the panel 30 due to the removal of a position indicator (PI) within the cab operator panel 30. The PI is typically a small display within the elevator unit which indicates to passengers the current floor that the elevator unit is located or is currently transiting. Therefore, the PI determines the elevator position disposed in the hoistway of an elevator system, where the elevator cab's current position is known at all times by the use of elevator positioning devices monitoring the elevator cab's position.

Referring to FIG. 1c, the display assembly unit 10 is shown assembled within the panel 30. The installation operation of the display assembly unit 10 with the panel 30 will now be described in greater detail below.

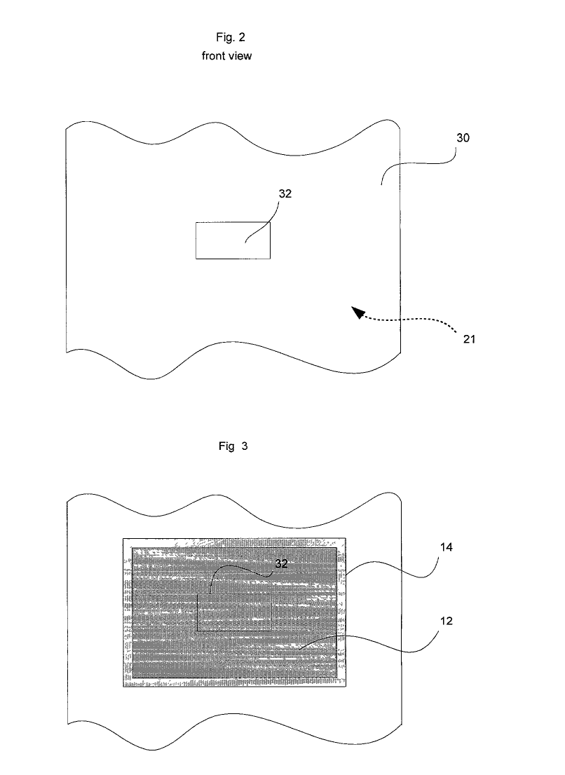

Referring to FIG. 2, the front surface 21 of the panel 30 is shown including the panel opening 32 prior to the installation of the display assembly unit 10.

Referring to FIG. 3, the front surface 21 is shown partially covered by the display plate 14 and the display 12 of the display assembly unit 10 which superimpose upon the panel opening 32, which is illistrated in ghost or dotted lines.

Referring to FIG. 4, the display 14 is shown viewed from the rear surface 23 mounted to the front surface 21 of the panel 30 with the display threaded studs 16a-16d of display plate 14 positioned within and extending through the panel opening 32. In this configuration, the display cable 38 attached to the display assembly unit 10 is also inserted through the panel opening 32 to be disposed in the rear surface 23 part of the panel 30. As illustrated in FIGS. 4-6, the display plate 14 and the display 12 are illustrated in ghost or dotted lines in the opposing front surface 21 to illustrate their relative position.

Referring to FIG. 5, the mounting plate 18 is shown attached to the rear surface 23 of the panel 30 where the mounting plate 18 is positioned to be mechanically connected to the display plate 14. Specifically, the mounting plate 18 includes mounting plate openings 26a-26d configured to receive and fasten to the display threaded studs 16a-16d of the display plate 14. In this example, the mounting plate 18 also includes mounting plate openings 26e-26h, positioned in axial alignment with the mounting plate openings 26a-26d. Although not utilized in this example as a fastening mechanism for attaching the display plate 14 to the mounting plate 18, the mounting plate openings 26e-26h are provided nonetheless to allow for easy adjustment of the position of the display assembly unit 10 depending on the size and shape of the existing panel opening 32. The mounting plate 18 further includes peripheral studs 20a-20d for receiving and fastening the mounting plate 18 to the mounting box 22 (FIG. 6). The display cable 38 is illustrated inserted through the cable opening 34 of the mounting plate 18.

Referring to FIG. 6, the rear surface 23 of the panel 30 is shown with the mounting box 22 mounted onto the opposite surface 19 of the mounting plate 18.

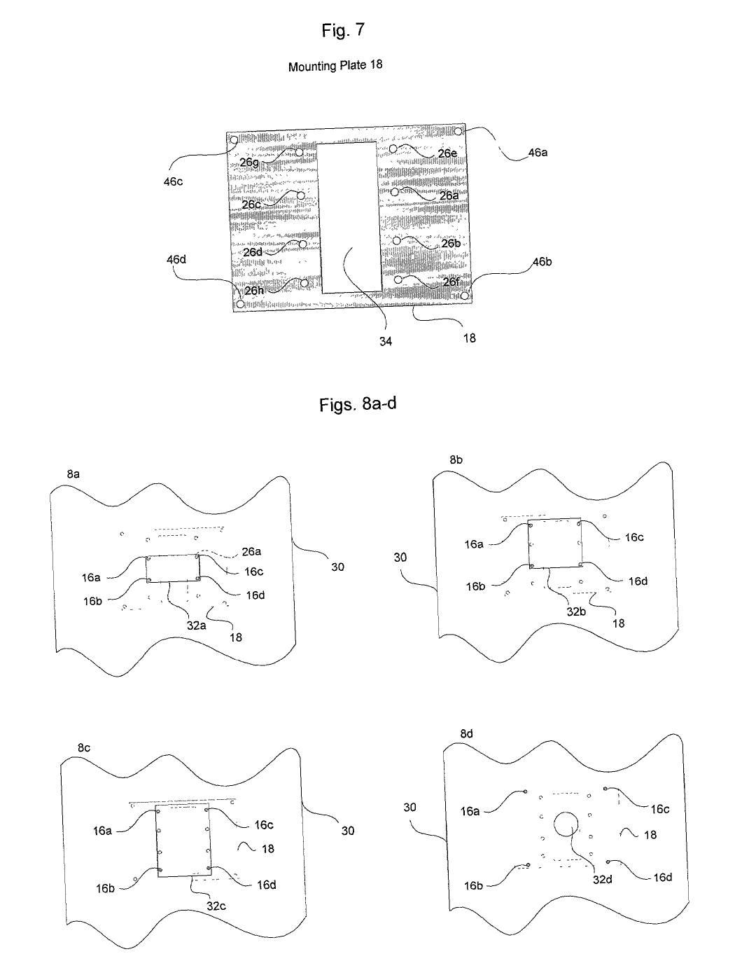

Referring to FIG. 7, adjustable combinations of the mounting plate openings 26a-26h are shown for receiving the display threaded studs 16a-16d of the display plate 14 in the rear surface 23 of the panel 30. This adjustable configuration allows the mounting plate 18 to fasten and mount with the display plate 14 irrespective of the shape and size of the panel opening 32.

Referring to FIGS. 8a-8d, the use of different combinations of the mounting plate openings 26a-26h (shown in dotted lines) are illustrated. The operation for using the various combinations of the mounting plate openings 26a-26h will be described in greater detail below.

The operation for the mounting of the display assembly unit 10 within a cab operator panel 30 of an elevator unit will now be described with reference to FIGS. 1-10.

In this embodiment, the display unit assembly 10 can be shipped to its installation location as an assembled unit as illustrated in FIG. 1a. Specifically, the display unit assembly 10 is shipped with the display threaded studs 16a-16d of the display plate 14 coupled with the mounting plate openings 26 of the mounting plate 18. Once the installation personnel have received the assembled display unit assembly 10, the unit 10 is disassembledand ready for installation onto the panel 30.

Typically, the panel opening 32 is a pre-existing aperture in the panel 30 of an elevator unit. The size of the panel opening 32 varies and its shape can have various shapes including circular, oval, rectangular, or square.

As discussed above, the panel opening 32 is commonly used as a PI, for example, of cab operator panels of an elevator.

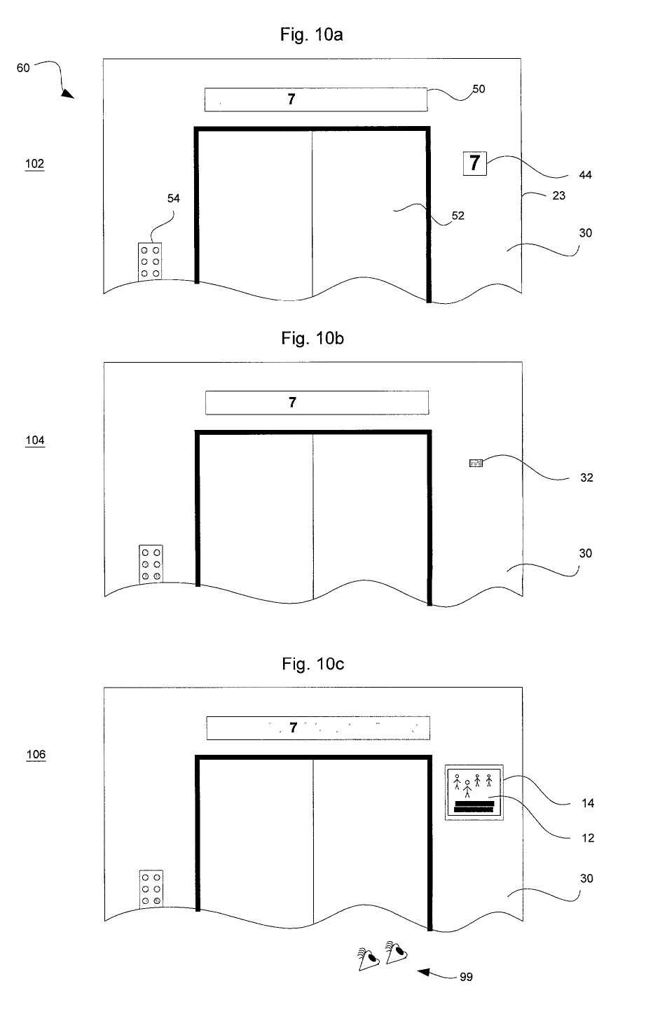

A set of PIs of an exemplary elevator cab 60 is illustrated in FIGS. 10a-10c. The elevator cab 60 includes two position indicators, a first PI 50 is positioned above the elevator doors 52. A second PI 44 is positioned on either side of the elevator cab doors 52 above the height of a position selector 54. Since elevator safety regulations generally require only one PI to be displayed within the elevator cab 60, the PI 44 is redundant and may be removed for use with other types of mounting display systems. Since the position of the PI 44 is generally provided at an optimal viewing height, the use of existing apertures such as those associated with PIs are well suited for installing information or display systems such as the display 12.

When the PI 44 is removed, an opening on the front surface 21 of the panel 30 originally used for mounting the PI 44 onto the panel 30 already exists. The pre-existing opening is used, in turn, for mounting the display assembly unit 10. In this example, once the PI 44 is removed, the panel opening 32 as shown in FIGS. 3 and 10b facilitates the mounting operation of the display assembly unit 10.

Referring to FIGS. 1 and 7-9 in particular, an example of a mounting operation 100 will now be described. Extracting the PI 44 typically requires removing four nuts from studs (not shown) welded to the rear surface 23 of the panel 30. The welded studs must be removed before the mounting operation 100 proceeds. In particular, the display threaded studs 16a-16d are inserted through the panel opening 32. The display cable 38 including the electronic and data cables such as the inverter power cable of display assembly unit 10 are also passed through the panel opening 32. Care is taken to gently guide the display cable 38 and any additional cables (not shown) through the panel opening 32 so that the display cable 38 is not pinched when fastening either the display panel 14 or the mounting plate 18 against the panel 30.

Depending on the size and shape of the panel opening 32, the display threaded studs 16a-16f can be selected so that the display threaded studs 16a-d can be inserted through the panel opening 32. The height of the position of the display threaded studs 16a-16d in the display plate 14 can be adjusted to fit the panel opening 32 to provide the most secure mounting configuration. For example, as illustrated in FIGS. 8a-8d, the shape of the panel opening 32 may vary considerably. In FIG. 8a, the panel opening 32a is rectangular, square in FIG. 8b, largest in FIG. 8c, and circular in FIG. 8d.

In the mounting operation 100, due to the variation in the shape and size of the panel opening 32 in the elevator cab 60, the mounting plate 18 provides an adjustable fastening mechanism by which the display threaded studs 16a-d of the display plate 14 can be received and joined to the corresponding mounting plate openings 26.

Referring to FIG. 7, the mounting plate 18 includes eight (8) mounting plate openings 26a-26h. The cable opening 34 is flanked by the mounting plate openings 26a-26b and 26e-26f on one side and the mounting plate openings 26c-26d and 26g-26h on the other.

Four mounting plate openings 26 are selected for an appropriate fit with the display threaded studs 16a-16d of the display plate 14. In particular, in FIG. 8a, the four mounting plate openings 26a-26d are selected to be slipped over the display threaded studs 16a-16d as well as passing the display cable 38 through the cable opening 34.

For example, still referring to FIG. 8a, the shape and size of the panel opening 32a is rectangular and based on its position, the threaded studs 16a-16d of the display plate 14 can fit within and through the panel opening 32a. During the installation of the display assembly unit 10, when the display plate 14 is attached to the front surface 21 of the panel 30 so that the opposite surface 15 contacts the front surface 21, the best match or fit for the threaded studs 16a-16d are the mounting plate openings 26a-26d.

Referring to FIG. 8b, the most appropriate fit for the display threaded studs 16a-16d are the mounting plate openings 26a, 26c, 26e, and 26g. Similarly, in FIG. 8c, openings 26e, 26f, 26g, and 26h are used, and in FIG. 8d, four additional openings (not shown) to accommodate the display threaded studs 16a-16d may are used. In FIG. 8d, if the panel opening 32 is circular as in the panel opening 32d, the display cable 38 is passed through the circular panel opening 32d and additional threaded studs and openings may be used for securely mounting the display plate 14 and the mounting plate 18 together.

As the mounting plate openings 26a-26h are slipped over the display threaded studs 16a-16d, a chemical adhesive or sealant used for threadlocking or threadsealing such as LOCTITE® Product 242, available from Loctite Corporation, of Rocky Hill, Conn., is applied to threadlockers or screws (not shown) which are placed or slipped over the display threaded studs 16 for secure mount of the display plate 14 to the mounting plate 18. LOCTITE® Product 242 cures when confined in the absence of air between close fitting metal surfaces and is particularly suitable for stainless steel nuts and bolts.

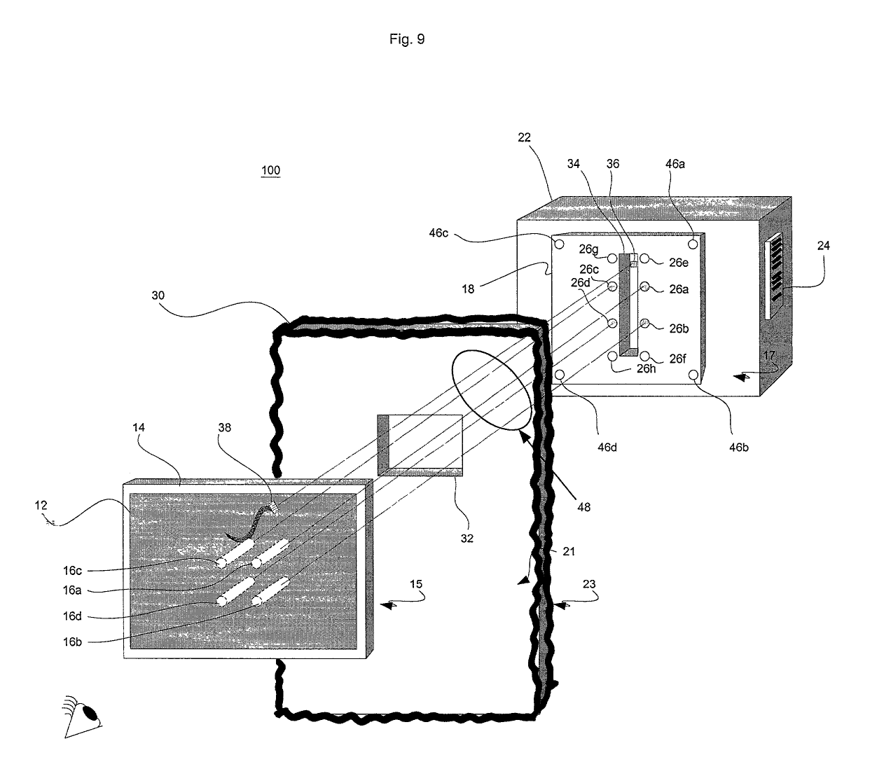

Referring back to FIG. 1c, once the installation is completed, the panel 30 becomes “sandwiched” between the display plate 14 and the mounting plate 18 which coordinately attach by a fastening mechanism of the display threaded studs 16a-16d and the mounting plate openings 26a-26d along the dotted lines 48 (FIG.9). FIG. 9 illustrates how the mounting operation 100 is achieved. Specifically, the panel 30 is fastened to the display plate 14, and in particular the opposite surface 15 of the display 14 contacts the front surface of the panel 30 and the panel contact surface 17 of the mounting plate contacts the rear surface of the panel 30.

Once the mounting plate 18 is securely fastened, the mounting box 22 is connected to the opposite surface 19 of the mounting plate 18 by the four peripheral studs 20a-20d of the mounting plate 18. In particular, referring back to FIGS. 1b and 1c, the mounting box apertures 28a and 28b receive the mounting threaded studs 20a and 20b of the opposite surface 19 in the mounting plate 18. Once the mounting box 22 is mounted onto the display assembly unit 10, as illustrated in FIG. 1c, the installation of the display assembly unit 10 is completed.

Referring to FIG. 10, the mounting operation 100 of FIG. 9 is shown in three distinct installation stages. In a first preparatory stage 102, the elevator cab 60 is shown with the first PI 50 and the second PI 44. The second redundant PI 44 is earmarked for removal for use in the installation of the display assembly unit 10. The display assembly unit 10 arrives as an assembled unit. Once disassembled, the display plate 14 and the mounting plate 18 are separated. Access to the rear surface 23 of the panel 30 of the elevator cab 60 is provided to the installation personnel.

In a second removal and installation stage 104, the PI 44 is removed and the size and shape of the panel opening 32 is surveyed and considered for the adjustment of the display threaded studs 16 for an appropriate fit with the panel opening 32. With access to the rear surface 23 of the panel 30, the display threaded studs 16 including the display cable 38 are passed through the panel opening 32 and the mounting operation 100 as described above with reference to FIGS. 1 and 7-9 is performed. The mounting box 22, once mounted onto the mounting plate 18 of the assembled display assembly unit 10 can now provide the required and necessary information for the visual information system. The visual information system can now be transmitted to the display 12 to be seen by passengers 99 who travel in the elevator cab 60.

Accordingly, other embodiments are within the scope of the following claims.

What is claimed is:

1. A system for mounting a display onto a panel having an opening, the system comprising:
a first plate supporting the display and contacting a first surface of the panel;
a second plate configured to contact a second surface opposite the first; and
a fastening mechanism for mounting the first plate and the second plate through the opening of the panel.

2. The system of claim 1 wherein the first plate includes a support surface for supporting the display and an opposite surface contacting the front surface of the panel.

3. The system of claim 1 wherein the first plate includes a plurality of fastening members.

4. The system of claim 3 wherein the second plate includes a plurality of openings.

5. The system of claim 4 wherein the fastening mechanism includes the plurality of fastening members configured to be inserted through the opening of the panel and join the plurality of openings.

6. The system of claim 1 further comprising a mounting box mechanically coupled with the second plate.

7. The system of claim 6 wherein the second opposite surface of the first plate includes a display cable inserted through the opening of the panel.

8. The system of claim 6 wherein the second plate includes a panel contact surface contacting the opposite surface of the panel, an opposite surface, and a cable opening for inserting the display cable through the opening.

9. The system of claim 8 wherein the opposite surface of the second plate includes a plurality of fastening members for mounting the second member to the mounting box.

10. The system of claim 4 wherein the number of the plurality of openings is greater than the number of the plurality of fastening members.

11. The system of claim 3 wherein the plurality of fastening members are threaded studs.

12. The system of claim 11 wherein the fastening mechanism includes threaded lockers attached to the threaded studs.

13. A method for mounting a display onto a panel having an opening, the method comprising:
providing a first plate supporting the display and contacting a first surface of the panel;
providing a second plate configured to contact a second surface opposite the first surface of the panel; and
fastening the first plate to the second plate through the opening of the panel.

14. The method of claim 13 wherein the first plate includes a support surface for supporting the display and an opposite surface contacting the front surface of the panel.

15. The method of claim 13 wherein the first plate includes a plurality of fastening members.

16. The method of claim 15 wherein the second plate includes a plurality of openings.

17. The method of claim 16 wherein the fastening mechanism includes the plurality of fastening members configured to be inserted through the opening of the panel and connect to the plurality of openings.

18. The method of claim 13 further comprising a mounting box mechanically coupled with the second plate.

19. The method of claim 18 wherein the second opposite surface of the first plate includes a display cable inserted through the opening of the panel.

20. The method of claim 18 wherein the second plate includes a panel contact surface contacting the opposite surface of the panel, an opposite surface, and a cable opening for inserting the display cable through the opening.

21. The method of claim 20 wherein the opposite surface of the second plate includes a plurality of fastening members for mounting the second member to the mounting box.

22. The method of claim 16 wherein the number of the plurality of openings is greater than the number of the plurality of fastening members.

23. A method for mounting a display onto a panel, the method comprising:
providing an opening in the panel;
providing a first plate supporting the display;
attaching the first plate to a first surface of the panel, wherein the first plate is positioned relative to the opening of the panel;
providing a second plate configured to contact a second surface opposite the first surface of the panel;
attaching the second plate to the second surface of the panel wherein the second plate is positioned relative to the opening of the panel; and
fastening the first plate and second plate through the opening of the panel.

24. The method of claim 23 further comprising removing a pre-existing display from the panel prior to providing the opening in the panel.

25. The method of claim 23 wherein the opening in the panel is provided prior to attaching the first plate onto the first surface of the panel.

26. A method comprising for mounting a display onto a panel, the method comprising:
providing an opening in the panel;
flanking the panel with a first and a second plate; and
connecting the first and the second plate through the opening of the panel.
